(19) United States
(12) Patent Application Publication
(10) Pub. No.: US 2004/0242432 A1
(43) Pub. Date: Dec. 2, 2004

(54) Friction material

(76) Inventors: Seiji Suzuki, Gunma-ken (JP); Yasuki Hattori, Gunma-ken (JP); Kazuhide Yamamoto, Gunma-ken (JP)

Correspondence Address: BIRCH STEWART KOLASCH & BIRCH, PO BOX 747, FALLS CHURCH, VA, 22040-0747, US

(21) Appl. No.: 10/854,331

(22) Filed: May 27, 2004

(30) Foreign Application Priority Data
May 28, 2003 (JP) 2003-150562

(51) Int. Cl. C10M 101/00; F16D 1/00; F16C 1/00

(52) U.S. Cl. 508/100; 508/103

(57) ABSTRACT

A friction material made of a molded and cured composition containing a fibrous base, a binder and a filler includes a specific amount of at least three substances of mutually differing melting points selected from the group consisting of metallic tin, tin alloys and tin compounds. Such friction materials greatly diminish mating surface attack.

### BACKGROUND OF THE INVENTION

1. Field of the Invention

The present invention relates to friction materials which can be used in such applications as disk pads, brake linings and clutch facings for automobiles and the like.

2. Prior Art

Friction materials used in automotive disk pads, brake linings and other similar applications generally include substances such as graphite and coke in order to improve wear resistance. In addition, lead and antimony compounds such as lead sulfide, antimony oxide and antimony sulfide are known to be effective for reducing mating surface attack due to scoring and other effects that arise at elevated temperatures. However, there is a growing tendency to avoid these lead and antimony compounds because of environmental concerns associated with their use.

The incorporation of metal sulfides as solid lubricants has also been described in the prior art, including JP-A 54-160, JP-A 54-109013, JP-A 4-311789, JP-A 7-83256, JP-B 8-26303, JP-A 10-511732, JP-A 2002-511517 and U.S. Pat. No. 6,228,815.

Yet, this prior art offers no effective solutions for minimization of mating surface attack. A desire thus exists for a way to minimize mating surface attack at both high loading times and low loading times.

### SUMMARY OF THE INVENTION

It is therefore an object of the present invention to provide a friction material which minimizes mating surface attack at both high loading times and low loading times.

We have discovered that metal pickup and mating surface attack by the friction material can be effectively suppressed and significantly minimized during high loading and low loading by including in the friction material a specific amount of at least three substances of mutually differing melting points selected from metallic tin, tin alloys and tin compounds, and especially bronze fibers, tin sulfide and tin powder.

Accordingly, the invention provides a friction material made by molding and curing a composition that contains a fibrous base, a binder and a filler, which friction material includes at least three substances of mutually differing melting points selected from the group consisting of metallic tin, tin alloys and tin compounds in a combined amount of 5.5 to 17.5 vol %.

The friction material typically includes 4 to 10 vol % of bronze fibers, 0.5 to 2.5 vol % of tin sulfide and 1 to 5 vol % of metallic tin powder. The bronze fibers are preferably of a type produced by a vibration cutting process. The tin sulfide is preferably a mixture of at least two types of tin sulfide.

### DETAILED DESCRIPTION OF THE INVENTION

The friction material of the invention contains a fibrous base, a binder and a filler.

The fibrous base may be any type of organic fiber (e.g., aramid fibers) or inorganic fiber (e.g., glass fibers, rock wool, metal fibers such as iron, copper or brass fibers) commonly used in friction materials. Any one or combination of two or more of these may be used.

The fibrous base is included in an amount of preferably 2 to 30 vol %, and more preferably 10 to 20 vol %, based on the overall friction material composition.

It is preferable for the fibrous base to have a fiber length of 2 to 3.5 mm and a fiber diameter of 60 to 120 μm.

The binder may be any known binder commonly used in friction materials. Illustrative examples of suitable binders include phenolic resins, melamine resins, epoxy resins; various modified phenolic resins such as epoxy-modified phenolic resins, oil-modified phenolic resins, alkylbenzene-modified phenolic resins and cashew-modified phenolic resins; and acrylonitrile-butadiene rubber (NBR). Any one or combinations of two or more of these may be used.

This binder is included in an amount of preferably 10 to 25 vol %, and more preferably 12 to 20 vol %, based on the overall friction material composition.

Illustrative examples of the filler include organic fillers such as various types of rubber powder (e.g., rubber dust, ground tire rubber), cashew dust and melamine dust; and inorganic fillers such as calcium carbonate, barium sulfate, magnesium oxide, graphite, calcium hydroxide, zirconium silicate, iron oxide, mica, zirconium oxide, metal powders, silicon oxide, alumina and vermiculite. Any one or combinations of two or more of these may be used.

These fillers are included in an amount of preferably 40 to 85 vol %, and more preferably 50 to 80 vol %, based on the overall friction material composition.

The friction material of the invention includes three or more substances of mutually differing melting points selected from the group consisting of metallic tin, tin alloys and tin compounds in a combined amount of 5.5 to 17.5 vol %, and preferably 7.5 to 15 vol %. Too small a combined amount of these three or more substances will not suffice to minimize metal pickup by the friction material, whereas too much will increase the cost of the friction material.

Specific examples of metallic tin that may be used include tin fibers and tin powder. Suitable examples of tin alloys include copper-tin bronzes and other alloys having a tin content of at least 6 wt %, and preferably at least 8 wt %. The tin alloy may be in the form of fibers or a powder. The tin compound may be a stannous compound or a stannic compound. Specific examples include SnS₂ and SnS. Tin substances in the form of fibers may be of the same size as indicated above for the fibrous base. Tin substances in the form of a powder may have an average particle size of preferably 3 to 20 μm, and more preferably 5 to 15 μm.

Of these substances, it is advantageous to use in combination the following three: moderate to high-melting bronze fibers and tin sulfide to minimize mating surface attack under high loading, and low-melting metallic tin powder to minimize mating surface attack under low loading. The use of 4 to 10 vol % of bronze fibers, 0.5 to 2.5 vol % of tin sulfide and 1 to 5 vol % of tin powder is preferred. Too little of any of these substances may lower the metal pickup-minimization effect, whereas too much may increase costs and, particularly in the case of metallic tin powder, diminish the fade performance of the friction material.

The bronze fibers are preferably fibers produced by a vibration cutting process because such fibers have a uniform shape. In addition, it is desirable for the tin sulfide to be a mixture of two or more types of tin sulfide, and particularly a mixture of SnS₂ and SnS. One commercially available tin sulfide mixture of this type that may be used is Stannolube, which is a combination of SnS₂, SnS and graphite manufactured by CHEMETALL S.A.

The friction material of the invention is generally produced by uniformly blending specific amounts of the above-described fibrous base, binder and filler in a suitable mixer such as a Henschel mixer, Loedige mixer or Eirich mixer, and preforming the blend in a mold. The preform is then molded at a temperature of 130 to 180° C. and a pressure of 150 to 500 kg/cm² (14.7 to 49 MPa) for a period of 3 to 10 minutes. The resulting molded article is typically postcured by heat treatment at 150 to 250° C. for 2 to 10 hours, then spray-painted, baked and surface-ground as needed to give the finished article.

In the case of automotive disk pads and brake linings, production may be carried out by placing the preform on an iron or aluminum plate that has been pre-washed, surface-treated and coated with an adhesive, molding the preform in this state within a mold, and subsequently heat-treating, spray-painting, baking and surface-grinding.

The friction material of the invention can be used in such applications as disk pads, brake shoes and brake linings for automobiles, large trucks, railroad cars and various types of industrial machinery.

### EXAMPLES

Examples of the invention and comparative examples are given below by way of illustration and not by way of limitation.

### Examples 1 to 5, Comparative Examples 1 to 7

Friction material compositions formulated as shown in Tables 1 to 3 were uniformly blended in a Loedige mixer and preformed in a pressure mold under a pressure of 30 MPa for a period of 1 minute. The preforms were molded for 7 minutes at a molding temperature and pressure of 150° C. and 40 MPa, then postcured by 5 hours of heat treatment at 220° C., yielding friction materials in the respective examples.

The rotor abrasion, bond strength and coefficient of friction for each of the resulting friction materials were evaluated as described below. The results are given in Tables 1 to 3.

[Rotor Abrasion]

Testing was carried out in accordance with the general wear tests described in JASO C427 (the test conditions are shown below in Table 4). In the tests, the speed at the start of braking was set at 30 to 80 km/h, the braking deceleration was 2 M/s², the brake temperature prior to braking was from 50 to 200° C., and the number of braking cycles was 1,600. Rotor Abrasion was rated as follows, based on the average roughness Rz for measurements at ten points (according to JIS B0601) on the rotor surface following test completion.

Good: less than 45 μm

Fair: at least 45 μm but less than 60 μm

Poor: 60 μm or more

[Bond Strength]

The bond strength per unit area was measured according to JIS D 4422.

Good: larger than 0.6 kN/cm²

Fair: larger than 0.5 kN/cm², but not more than 0.6 kN/cm²

Poor: 0.5 kN/cm² or less

[Friction Coefficient]

The average friction coefficient in the second effectiveness test conducted as described in JASO C406 was rated as follows.

Good: Larger than 0.37

Fair: Larger than 0.32, but not more than 0.37

Poor: 0.32 or less

TABLE 1

| Ingredients | Example | | | | |
|---|---|---|---|---|---|
| (volume %) | 1 | 2 | 3 | 4 | 5 |
| Stainless steel fibers | 5.0 | 5.0 | 9.5 | 5.0 | 5.0 |
| Bronze fibers | 9.0 | 4.5 | 4.5 | 9.0 | 9.0 |
| Copper fibers | 0.0 | 0.0 | 0.0 | 0.0 | 0.0 |
| Brass fibers | 0.0 | 0.0 | 0.0 | 0.0 | 0.0 |
| Atomized tin powder | 3.0 | 3.0 | 3.0 | 6.0 | 3.0 |
| Tin sulfide powder | 1.5 | 1.5 | 1.5 | 1.5 | 4.0 |
| Aramid fibers | 3.0 | 3.0 | 3.0 | 3.0 | 3.0 |
| Slaked lime | 3.0 | 3.0 | 3.0 | 3.0 | 3.0 |
| Barium sulfate | 24.0 | 28.5 | 24.0 | 21.0 | 22.5 |
| Vermiculite | 10.0 | 10.0 | 10.0 | 10.0 | 10.0 |
| Graphite | 9.0 | 9.0 | 9.0 | 9.0 | 9.0 |
| Molybdenum disulfide | 1.5 | 1.5 | 1.5 | 1.5 | 1.5 |
| Iron sulfide | 5.0 | 5.0 | 5.0 | 5.0 | 5.0 |
| Phenolic resin | 15.0 | 15.0 | 15.0 | 15.0 | 15.0 |
| Cashew dust | 7.0 | 7.0 | 7.0 | 7.0 | 7.0 |
| Rubber | 3.0 | 3.0 | 3.0 | 3.0 | 3.0 |
| Alumina powder | 1.0 | 1.0 | 1.0 | 1.0 | 1.0 |
| Total | 100.0 | 100.0 | 100.0 | 100.0 | 100.0 |
| Rotor abrasion | good | fair | fair | good | good |
| Bond strength | good | fair | good | good | good |
| Friction coefficient | good | good | good | fair | fair |

TABLE 2

| | |
|---|---|
| Ingredients | Comparative Example |

| (volume %) | 1 | 2 | 3 | 4 |
|---|---|---|---|---|
| Stainless steel fibers | 5.0 | 5.0 | 5.0 | 5.0 |
| Bronze fibers | 0.0 | 0.0 | 9.0 | 9.0 |
| Copper fibers | 9.0 | 0.0 | 0.0 | 0.0 |
| Brass fibers | 0.0 | 9.0 | 0.0 | 0.0 |
| Atomized tin powder | 3.0 | 3.0 | 0.0 | 0.0 |
| Tin sulfide powder | 1.5 | 1.5 | 1.5 | 4.5 |
| Aramid fibers | 3.0 | 3.0 | 3.0 | 3.0 |
| Slaked lime | 3.0 | 3.0 | 3.0 | 3.0 |
| Barium sulfate | 24.0 | 24.0 | 27.0 | 24.0 |
| Vermiculite | 10.0 | 10.0 | 10.0 | 10.0 |
| Graphite | 9.0 | 9.0 | 9.0 | 9.0 |
| Molybdenum disulfide | 1.5 | 1.5 | 1.5 | 1.5 |
| Iron sulfide | 5.0 | 5.0 | 5.0 | 5.0 |
| Phenolic resin | 15.0 | 15.0 | 15.0 | 15.0 |
| Cashew dust | 7.0 | 7.0 | 7.0 | 7.0 |
| Rubber | 3.0 | 3.0 | 3.0 | 3.0 |
| Alumina powder | 1.0 | 1.0 | 1.0 | 1.0 |
| Total | 100.0 | 100.0 | 100.0 | 100.0 |
| Rotor abrasion | poor | poor | poor | fair |
| Bond strength | good | good | good | good |
| Friction coefficient | good | good | good | poor |

TABLE 3

| Ingredients | Comparative Example | | |
|---|---|---|---|
| (volume %) | 5 | 6 | 7 |

| | | | |
|---|---|---|---|
| Stainless steel fibers | 5.0 | 5.0 | 5.0 |
| Bronze fibers | 9.0 | 9.0 | 9.0 |
| Copper fibers | 0.0 | 0.0 | 0.0 |
| Brass fibers | 0.0 | 0.0 | 0.0 |
| Atomized tin powder | 3.0 | 3.0 | 3.0 |
| Tin sulfide powder | 0.0 | 0.0 | 0.0 |
| Aramid fibers | 3.0 | 3.0 | 3.0 |
| Slaked lime | 3.0 | 3.0 | 3.0 |
| Barium sulfate | 25.5 | 24.0 | 24.0 |
| Vermiculite | 10.0 | 10.0 | 10.0 |
| Graphite | 9.0 | 10.5 | 9.0 |
| Molybdenum disulfide | 1.5 | 1.5 | 3.0 |
| Iron sulfide | 5.0 | 5.0 | 5.0 |
| Phenolic resin | 15.0 | 15.0 | 15.0 |
| Cashew dust | 7.0 | 7.0 | 7.0 |
| Rubber | 3.0 | 3.0 | 3.0 |
| Alumina powder | 1.0 | 1.0 | 1.0 |
| Total | 100.0 | 100.0 | 100.0 |
| Rotor abrasion | poor | poor | poor |
| Bond strength | good | good | good |
| Friction coefficient | good | good | good |

Bronze fibers:Produced by vibration cutting process. length, 2.2 mm. Diameter, 95 μm. Melting point, 934° C.

Tin sulfide powder: Stannolube (produced by CHEMETALL S.A.; SnS₂+SnS+graphite). Particle size, 10 μm. Melting point, 860° C.

Atomized tin powder: Average particle size, 15 μm. Melting point, 232° C.

TABLE 4
Rotor Abrasion Test Conditions

| | | Speed at | | Brake | |
|---|---|---|---|---|---|
| | | start of | Braking | temperature | |
| | | braking | deceleration | before braking | Number of |
| No. | Test | (km/h) | (m/s²) | (° C.) | braking cycles |
| 1 | Breaking in* | 50 | 2.9 | 100 | 200 |
| 2 | Wear test 1 | 30 | 2 | 50 | 100 cycles each time |
| | | | | 100 | Total of 7 × 100 = |
| | | | | 150 | 700 cycles |
| | | | | 200 | |
| | | | | 150 | |
| | | | | 100 | |
| | | | | 50 | |
| 3 | Wear test 2 | 50 | 2 | 50 | 100 cycles each time |
| | | | | 100 | Total of 5 × 100 = |
| | | | | 200 | 500 cycles |
| | | | | 100 | |
| | | | | 50 | |
| 4 | Wear test 3 | 80 | 2 | 100 | 100 cycles each time |
| | | | | 200 | Total of 2 × 100 = |
| | | | | | 200 cycles |

*In accordance with wear test described in JASO C427-88.

As is apparent from the foregoing results, the friction materials of the invention greatly diminish mating surface attack.

Japanese Patent Application No. 2003-150562 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A friction material made by molding and curing a composition comprising a fibrous base, a binder and a filler, which friction material includes of at least three substances of mutually differing melting points selected from the group consisting of metallic tin, tin alloys and tin compounds in a combined amount of 5.5 to 17.5 vol %.

2. The friction material of claim 1, which includes 4 to 10 vol % of bronze fibers, 0.5 to 2.5 vol % of tin sulfide and 1 to 5 vol % of metallic tin powder.

3. The friction material of claim 2, wherein the bronze fibers are produced by a vibration cutting process.

4. The friction material of claim 2, wherein the tin sulfide is a mixture of at least two types of tin sulfide.
